(19) United States
(12) Patent Application Publication
(10) Pub. No.: US 2015/0305542 A1
(43) Pub. Date: Oct. 29, 2015

(54) Multiple Purpose Cooking Assembly

(71) Applicant: Cornelia Burney, Chicago, IL (US)

(72) Inventor: Cornelia Burney, Chicago, IL (US)

(21) Appl. No.: 14/259,622

(22) Filed: Apr. 23, 2014

(51) Int. Cl. A47J 27/62; A47J 37/07; F24C 7/08; A47J 37/06

(52) U.S. Cl. CPC A47J 27/62; A47J 37/06; A47J 37/07; A47J 37/0676; A47J 37/0709; A47J 37/0763; F24C 7/088; A47J 2201/00

(57) ABSTRACT

A multiple purpose cooking assembly for simultaneously roasting, barbequing and grilling includes a housing that has a plurality of cooking spaces in it. The housing is positionable indoors or outdoors. A processor is coupled to the housing. A heat source is operationally coupled to the housing. The heat source provides cooking heat to each of the plurality of cooking spaces. Each of the plurality of cooking spaces employs the cooking heat in a variety of manners. A heat actuator is operationally coupled to the housing. The heat actuator is operationally coupled to the heat source so the heat actuator adjusts an temperature of the heat source. A timer actuator is operationally coupled to the housing. The timer actuator is operationally coupled to the heat source. The timer actuator de-actuates the heat source after a pre-selected duration of time.

### BACKGROUND OF THE DISCLOSURE

### Field of the Disclosure

The disclosure relates to multiple purpose cooking devices and more particularly pertains to a new multiple purpose cooking device for simultaneously roasting, barbequing and grilling.

### SUMMARY OF THE DISCLOSURE

An embodiment of the disclosure meets the needs presented above by generally comprising a housing that has a plurality of cooking spaces in it. The housing is positionable indoors or outdoors. A processor is coupled to the housing. A heat source is operationally coupled to the housing. The heat source provides cooking heat to each of the plurality of cooking spaces. Each of the plurality of cooking spaces employs the cooking heat in a variety of manners. A heat actuator is operationally coupled to the housing. The heat actuator is operationally coupled to the heat source so the heat actuator adjusts an temperature of the heat source. A timer actuator is operationally coupled to the housing. The timer actuator is operationally coupled to the heat source. The timer actuator de-actuates the heat source after a pre-selected duration of time.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a multiple purpose cooking assembly according to an embodiment of the disclosure.

FIG. 2 is a back view of an embodiment of the disclosure.

FIG. 3 is a front view of an embodiment of the disclosure.

FIG. 4 is a left view of an embodiment of the disclosure.

FIG. 5 is a schematic view of an embodiment of the disclosure.

### DESCRIPTION OF THE PREFERRED EMBODIMENT

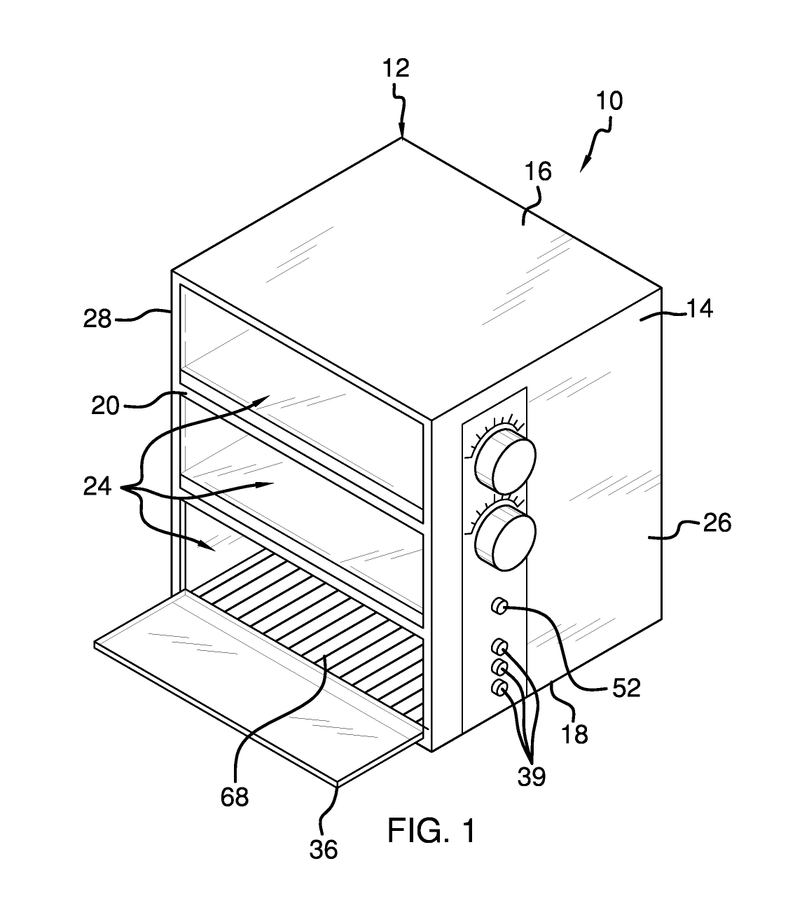

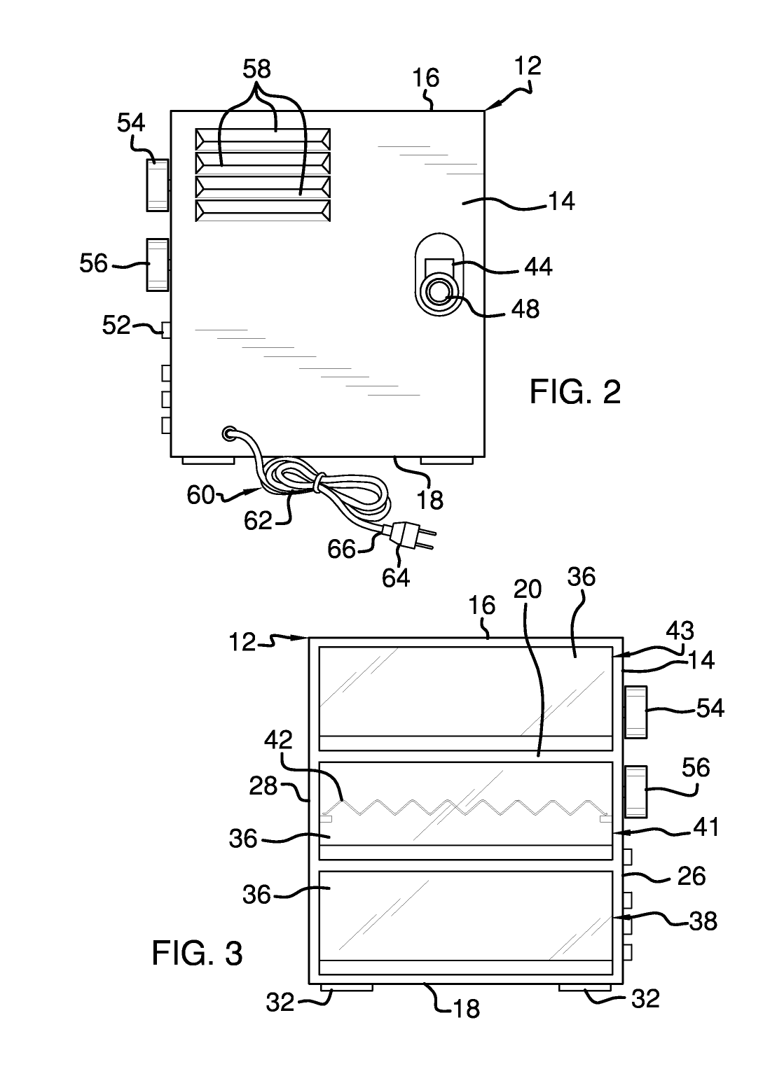

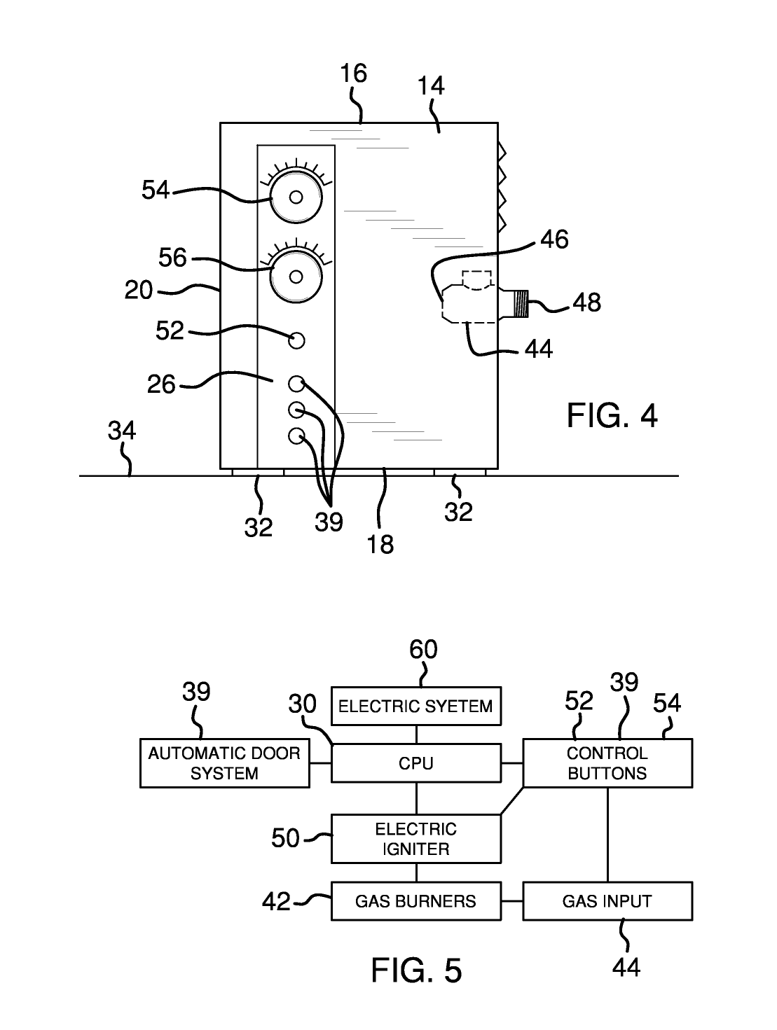

With reference now to the drawings, and in particular to FIGS. 1 through 5 thereof, a new multiple purpose cooking device embodying the principles and concepts of an embodiment of the disclosure and generally designated by the reference numeral 10 will be described.

As best illustrated in FIGS. 1 through 6, the multiple purpose cooking assembly 10 generally comprises a housing 12 that has an outer wall 14 extending between a top wall 16 and a bottom wall 18 of the housing 12. The housing 12 has a rectangular parallelepiped shape. Moreover, the housing 12 may be positioned indoors or outdoors. The outer 14, top 16 and bottom 18 walls of the housing 12 may be comprised of a heat resistant material.

A front side 20 of the outer wall 14 of the housing 12 has a plurality of wells 22 extending rearwardly toward a back side 24 of the outer wall 14 of the housing 12. The plurality of wells 22 extend between a first lateral side 26 and a second lateral side 28 of the outer wall 14 of the housing 12. Additionally, the plurality of wells 22 is evenly spaced apart and distributed between the top wall 16 and the bottom wall 18 of the housing 12. A processor 30 is coupled to the housing 12. The processor 30 may be an electronic processor of any conventional design.

A plurality of feet 32 is coupled to the bottom wall 18 of the housing 12. The plurality of feet 32 are each positioned proximate an associated one of four corners of the bottom wall 18 of the housing 12. The plurality of feet 32 abut a support surface 34 so the housing 12 is supported above the support surface 34. The support surface 34 may be a table top or other similar support surface.

A plurality of doors 36 is each hingedly coupled to the front side 20 of the outer wall 14 of the housing 12. Each of the plurality of doors 36 covers an associated one of a grilling one 38, a barbeque one 41 and a roasting one 43 of the plurality of wells. The plurality of doors 36 each is electrically coupled to the processor 30 so the processor 30 actuates the each of the plurality of doors 36 between a closed and an open position. Finally, each of the plurality of doors 36 may be comprised of a translucent and heat resistant material.

A plurality of door actuators 39 is coupled to a first lateral side 40 of the outer wall 14 of the housing 12. The plurality of door actuators 39 each is electrically coupled to the processor 30. The processor 30 actuates an associated one of the plurality of doors 36 to the open position when an associated one of the plurality of door actuators 39 is actuated. Finally, the plurality of door actuators 39 is positioned proximate the front side 20 of the outer wall 14 of the housing 12.

A heat source 42 is coupled between the first lateral side 26 and the second lateral side 28 of the outer wall 14 of the housing 12. The heat source 42 is positioned within the barbeque well 41. The heat source 42 provides a cooking heat to each of the plurality of wells 22. Finally, the heat source 42 may be a gas burner of any conventional design.

The barbeque well 41 cooks with a direct heat from the heat source 42. Additionally, the barbeque well 41 cooks over a minimum amount of time. The grilling well 38 is positioned below the barbeque well 41. The grilling well 38 receives an indirect heat from the heat source 42. Moreover, the grilling well 38 capitalizes on the cooking heat rising upwardly from the barbeque well 41. The grilling well 38 cooks over a maximum amount of time.

The roasting well 43 is positioned above the barbeque well 41. The roasting well 43 receives an indirect heat from the heat source 42. The roasting well 43 capitalizes on the cooking heat rising upwardly from the barbeque well 41. Moreover, the roasting well 43 cooks over a medial amount of time.

A valve 44 extends through the back side 24 of the outer wall 14 of the housing 12 proximate the second lateral side 28 of the outer wall 14 of the housing 12. An interior end 46 of the valve 44 is fluidly coupled to the heat source 42. An exterior end 48 of the valve 44 is exposed proximate the back side 24 of the outer wall 14 of the housing 12. The valve 44 may be a pressurized fuel valve of any conventional design. The exterior end 48 of the valve 44 is fluidly coupled to a fuel supply so the valve 44 delivers a fuel to the heat source 42. The fuel may be propane.

An igniter 50 is coupled to the heat source 42. An igniter actuator 52 is coupled to the first lateral side 26 of the outer wall 14 of the housing 12. The igniter actuator 52 is electrically coupled to the igniter 50. The igniter 50 ignites the fuel being expelled from the heat source 42. Finally, the igniter 50 may be an electro-static igniter of any conventional design.

A heat actuator 54 is rotatably coupled to the first lateral side 26 of the outer wall 14 of the housing 12. The heat actuator 54 is positioned adjacent to the front side 20 of the outer wall 14 of the housing 12 and the top wall 16 of the housing 12. The heat actuator 54 is fluidly coupled to the valve 44 so the heat actuator 54 adjusts a flow of a fuel to the heat source 42 between a minimum and a maximum rate. The heat actuator 54 comprises a knob that may be rotated.

A timer actuator 56 is coupled to the first lateral side 26 of the outer wall 14 of the housing 12. The timer actuator 56 is positioned adjacent to the front side 20 of the outer wall 14 of the housing 12 and the heat actuator 54. The timer actuator 56 is actuatable between a minimum and a maximum duration of time. Additionally, the duration of time may range between five minutes and sixty minutes. The timer actuator 56 is fluidly coupled to the valve 44. Moreover, the timer actuator 56 closes the valve 44 after the selected duration of time. The timer actuator 56 comprises a timer of any conventional design.

A plurality of vents 58 extends through the back side 24 of the outer wall 14 of the housing 12. The plurality of vents 58 are positioned adjacent to the first lateral side 26 of the outer wall 14 of the housing 12 and the top wall 16 of the housing 12. Air circulates outwardly from an interior of the housing 12 through each of the plurality of vents 58.

A power supply 60 is coupled to the housing 12. The power supply 60 is electrically coupled to the processor 30. The power supply 60 comprises a cord 62 extending outwardly from the back side 24 of the outer wall 14 of the housing 12. A plug 64 on a free end 66 of the cord 62 is electrically coupled to a power source. The power source may be an electrical outlet of any conventional design.

A grill 68 is removably positioned within the grilling well 38. The grill 68 extends between the front 20 and back 24 sides of the outer wall 14 of the housing 12. Additionally, the grill 68 extends between the first 26 and second 28 lateral sides of the housing 12. Items to be cooked by grilling are positioned on the grill 68.

In use, an item to be cooked is positioned within a selected one of the grilling 38, barbeque 41 or roasting 43 wells. The barbeque well 41 provides a direct heat for cooking. Each of the roasting 43 and grilling 38 wells provides an indirect heat for cooking. The grilling well 38 is utilized to cook over the maximum amount of time. Additionally, the grilling well 38 is utilized the cook in the convention of grilling.

The roasting well 43 is utilized to cook over the medial amount of time. Additionally, the roasting well 43 is utilized to cook in the convention of roasting. The heat actuator 54 is set to a desired temperature so the valve 44 begins delivering the fuel to the heat source 42. The igniter actuator 52 is actuated to ignite the fuel. The timer actuator 56 is set to the desired time. A plurality of items may be cooked simultaneously in each of the grilling 38, barbeque 41 or roasting 43 wells.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A multiple purpose cooking assembly configured to simultaneously roast, barbeque and grill, said assembly comprising:
a housing having a plurality of cooking spaces therein, said housing being positionable indoors or outdoors;
a processor coupled to said housing;
a heat source operationally coupled to said housing, said heat source providing cooking heat to each of said plurality of cooking spaces such that each of said plurality of cooking spaces employs the cooking heat in a variety of manners;
a heat actuator operationally coupled to said housing, said heat actuator being operationally coupled to said heat source such that said heat actuator adjusts an temperature of said heat source; and
a timer actuator operationally coupled to said housing, said timer actuator being operationally coupled to said heat source, said timer actuator de-actuating said heat source after a pre-selected duration of time.

2. The assembly according to claim 1, wherein said housing having an outer wall extending between a top wall and a bottom wall of said housing such that said housing has a rectangular parallelepiped shape.

3. The assembly according to claim 1, wherein a front side of an outer wall of said housing have a plurality of wells extending rearwardly toward a back side of said outer wall of said housing.

4. The assembly according to claim 3, wherein said plurality of wells extending between a first lateral side and a second lateral side of said outer wall of said housing, said plurality of wells being evenly spaced apart and distributed between a top wall and a bottom wall of said housing.

5. The assembly according to claim 1, wherein said heat source being coupled between a first lateral side and a second lateral side of an outer wall of said housing such that said heat source is positioned within a barbeque one of a plurality of wells.

6. The assembly according to claim 5, wherein said barbeque well cooking with a direct heat from said heat source.

7. The assembly according to claim 1, wherein a grilling one of said plurality of wells being positioned below a barbeque well such that said grilling well receives an indirect heat from said heat source.

8. The assembly according to claim 1, wherein a roasting one of said plurality of wells being positioned above a barbeque well such that said roasting well receives an indirect heat from said heat source.

9. The assembly according to claim 1, wherein a valve extending through a back side of an outer wall of said housing, an interior end of said valve being fluidly coupled to said heat source.

10. The assembly according to claim 9, wherein an exterior end of said valve being exposed proximate said back side of said outer wall of said housing, said exterior end of said valve being fluidly coupled to a fuel supply such that said valve delivers a fuel to said heat source.

11. The assembly according to claim 1, wherein said heat actuator being coupled to a first lateral side of an outer wall of said housing, said heat actuator being positioned adjacent to a front side of said outer wall of said housing and a top wall of said housing.

12. The assembly according to claim 1, wherein said heat actuator being fluidly coupled to a valve such that said heat actuator adjusts a flow of a fuel to said heat source between a minimum and a maximum rate.

13. The assembly according to claim 1, wherein said timer actuator being coupled to a first lateral side of an outer wall of said housing, said timer actuator being positioned adjacent to a front side of said outer wall of said housing and said heat actuator.

14. The assembly according to claim 1, wherein said timer actuator being actuatable between a minimum and a maximum duration of time, said timer actuator being fluidly coupled to a valve such that said timer actuator closes said valve after the selected duration of time.

15. The assembly according to claim 1, wherein:
a power supply coupled to said housing;
said power supply being electrically coupled to said processor;
said power supply comprising a cord extending outwardly from a back side of an outer wall of said housing; and
a plug on a free end of said cord being electrically coupled to a power source.

16. A multiple purpose cooking assembly configured to simultaneously roast, barbeque and grill, said assembly comprising:
a housing having an outer wall extending between a top wall and a bottom wall of said housing such that said housing has a rectangular parallelepiped shape, said housing being positionable indoors or outdoors;
a front side of said outer wall of said housing have a plurality of wells extending rearwardly toward a back side of said outer wall of said housing, said plurality of wells extending between a first lateral side and a second lateral side of said outer wall of said housing, said plurality of wells being evenly spaced apart and distributed between said top wall and said bottom wall of said housing;
a processor coupled to said housing;
a heat source coupled between said first lateral side and said second lateral side of said outer wall of said housing such that said heat source is positioned within a barbeque one of said plurality of wells;
said barbeque well cooking with a direct heat from said heat source;
a grilling one of said plurality of wells being positioned below said barbeque well such that said grilling well receives an indirect heat from said heat source;
a roasting one of said plurality of wells being positioned above said barbeque well such that said roasting well receives an indirect heat from said heat source;
a valve extending through said back side of said outer wall of said housing, an interior end of said valve being fluidly coupled to said heat source, an exterior end of said valve being exposed proximate said back side of said outer wall of said housing, said exterior end of said valve being fluidly coupled to a fuel supply such that said valve delivers a fuel to said heat source;
a heat actuator rotatably coupled to said first lateral side of said outer wall of said housing, said heat actuator being positioned adjacent to said front side of said outer wall of said housing and said top wall of said housing, said heat actuator being fluidly coupled to said valve such that said heat actuator adjusts a flow of a fuel to said heat source between a minimum and a maximum rate;
a timer actuator coupled to said first lateral side of said outer wall of said housing, said timer actuator being positioned adjacent to said front side of said outer wall of said housing and said heat actuator, said timer actuator being actuatable between a minimum and a maximum duration of time, said timer actuator being fluidly coupled to said valve such that said timer actuator closes said valve after the selected duration of time; and
a power supply coupled to said housing, said power supply being electrically coupled to said processor, said power supply comprising a cord extending outwardly from said back side of said outer wall of said housing, a plug on a free end of said cord being electrically coupled to a power source.
